(19) United States
(12) Patent Application Publication
(10) Pub. No.: US 2002/0009060 A1
(43) Pub. Date: Jan. 24, 2002

(54) Satellite transceiver card for bandwidth on demand applications

(76) Inventor: Todd Gross, Sunrise, FL (US)

Correspondence Address: Banner & Witcoff, LTD, Att: Douglas Robinson, 1001 G. Street, N.W., Washington, DC, 20001-4597, US

(21) Appl. No.: 09/849,623

(22) Filed: May 7, 2001

Related U.S. Application Data
(60) Provisional application No. 60/202,113, filed on May 5, 2000.

(51) Int. Cl. H04B 7/212

(52) U.S. Cl. 370/321; 370/316

(57) ABSTRACT

A satellite transceiver card for use in a communication system is provided. The satellite transceiver card can selectively adjusting bandwidth allocation or provide voice across a satellite communication system supporting Internet related applications. The satellite transceiver card may simply be a TDMA or single carrier per channel based transceiver, and can adapt to different rates and/or frequencies. The satellite transceiver card may include one or more high speed receiver(s) receiving one or more high speed downlink channels. The satellite transceiver card may also include one or more uplink transmitter(s). The uplink transmitter may be a single carrier per channel, a TDMA based system, or an adaptive system allowing dynamic reconfiguration of the uplink channel bandwidth and/or frequency. The transmitter may adapt to anyone of a number of different frequencies and/or channels. Where the transmitter card includes adaptive circuitry, an earth station may dynamically reconfigure the uplink bandwidth to add additional channels and/or switch to higher capacity channels, so that the earth station may adapt to changes in demand.

This is a utility application claiming priority from provisional application Ser. No. 60/202,113 filed May 5, 2000.

### FIELD OF THE INVENTION

The present invention relates to a satellite transceiver card for use in a communication system and method for operating the satellite transceiver card. More particularly, the present invention relates to a satellite transceiver card and method for selectively adjusting bandwidth allocation or providing voice across a satellite communication system supporting Internet related applications.

### BACKGROUND OF THE INVENTION

Many wide area networks, particularly in rural areas are implemented using very small aperture terminals (VSAT) satellite systems. These systems are often designed for the distribution of high-speed Internet data, voice data, and video data. Conventionally, these systems were implemented using a TDM/TDMA multiplexing scheme employing X.25 protocol at every node and proved very inefficient in distributing voice in conjunction with data (including Internet data) and video.

Typically, systems such as these were very inefficient, even where they included bandwidth on demand (BOD) schemes such as TDM/TDMA based schemes. Even in ideal situations, inbound link efficiencies for TDM/TDMA based bandwidth on demand schemes are only about 70% efficient, with many systems deteriorating to about 30% efficient. Although fixed bandwidth schemes are substantially more efficient when the entire bandwidth is being utilized, the link is often under utilized during most of the day. Thus, the fixed bandwidth systems suffer from the same problem as the TDM/TDMA based systems.

A major improvement in this architecture came with the use of a frame relay type protocol (e.g., an efficient protocol without error correction). See, for example, U.S. Pat. No. 5,343,850. Using these types of protocols, it is possible to substantially increase efficiencies where many VSAT terminals are connected in a point to multipoint configuration.

In certain embodiments, it is possible to utilize systems employing efficient protocols with or without a hub. In these systems, efficiencies may be maximized by utilizing schemes which include a committed information rate on the upstream and/or downstream link with stations competing for any excess bandwidth over the committed information rate. In systems where the downlink data is consolidated using a hub station and a high speed downlink path and the individual VSAT terminals are implemented using a single carrier per channel, efficiencies can be as high as 98%. In typical applications, a hub station is utilized which includes high speed backbone access to the Internet either directly or through one or more Internet Service Providers (ISPs). Where a hub is utilized, the high speed backbone access to the Internet may be made substantially more efficient by aggregating users from many VSAT terminals into a single high speed backbone. Although the aforementioned system is highly efficient, there may still exist some efficiencies associated with the return path from each of the individual earth stations.

One particular scheme for addressing the upstream return path is to utilize the uplink queue levels. Where the uplink queue in each earth station passes an upper threshold, the earth station may be configured to send a message to a network management system. Responsive to the messages, the network management system may dynamically allocate excess resources to those earth stations which have queue levels above a certain threshold. Likewise, when the queue levels drop below a low selectable level, the network management system may deallocate the resources for use by other earth stations. For example, a typical bandwidth on demand scheme is described in U.S. Pat. No. 5,841,765. Although this scheme has substantially improved the bandwidth utilization, there is still a need to reduce the allocation and reallocation of resources on a predictable basis to minimize the need to reacquire synchronization and associated inefficiencies.

### SUMMARY OF THE INVENTION

Aspects of the invention include providing broadband access capabilities or enhanced services for use in conjunction with VSAT satellite networks having increased efficiencies. Other aspects of the invention include providing one or more of the following either individually, or in any combination or subcombination:

a new VSAT architecture;

new bandwidth on demand allocation scheme for VSAT terminals;

enhanced services for use in conjunction with VSAT terminals;

integrated home telephony, Internet access, and direct broadcast television using a single receive signal source;

enhanced compatibility between satellite transmission over VSAT terminals and Internet Protocol (IP) based system infrastructures;

a highly efficient communications system for allocating bandwidth among different VSAT terminals in geographic disperse areas (e.g., when using wide beam satellites having large footprints) based on patterns of usage;

methods and apparatus for analyzing patterns of usage based on geographic location and time and reconfiguring the network based on usage patterns; and

methods and apparatus for mapping IP voice, data, and telephony over a satellite network for bypassing local phone and cable companies.

Although the invention has been defined using the appended claims, the invention is meant to include one or more elements from the apparatus and methods described herein. Accordingly, there are any number of alternative combinations for defining the invention, which incorporate one or more elements from the specification (including the elements outlined in the summary, drawings, and claims) in any combinations or subcombinations.

### BRIEF DESCRIPTION OF THE DRAWINGS

FIG. 1 shows a block diagram of a broadband satellite based network in accordance with a first embodiment of aspects of the present invention.

FIG. 2 shows a block diagram of a second embodiment of a broadband satellite based network in accordance with aspects of the present invention.

FIG. 3 shows a block diagram of a dynamic reconfigurable transceiver in accordance with aspects of the present invention.

FIG. 4 shows a detailed block diagram of an exemplary earth station in accordance with aspects of the invention.

FIG. 5 shows a partial block, partial pictorial diagram of an earth station consistent with that shown in FIG. 4.

FIG. 6 is a partial block, partial flow diagram of an embodiment of an earth station consistent with that shown in FIG. 4.

FIG. 7 is a partial block, partial flow diagram of an embodiment of an earth station consistent with that shown in FIG. 4.

FIG. 8 is a traffic pattern analysis showing how time dependent peak data flow may be aggregated over various regions.

### DETAILED DESCRIPTION OF PREFERRED EMBODIMENTS

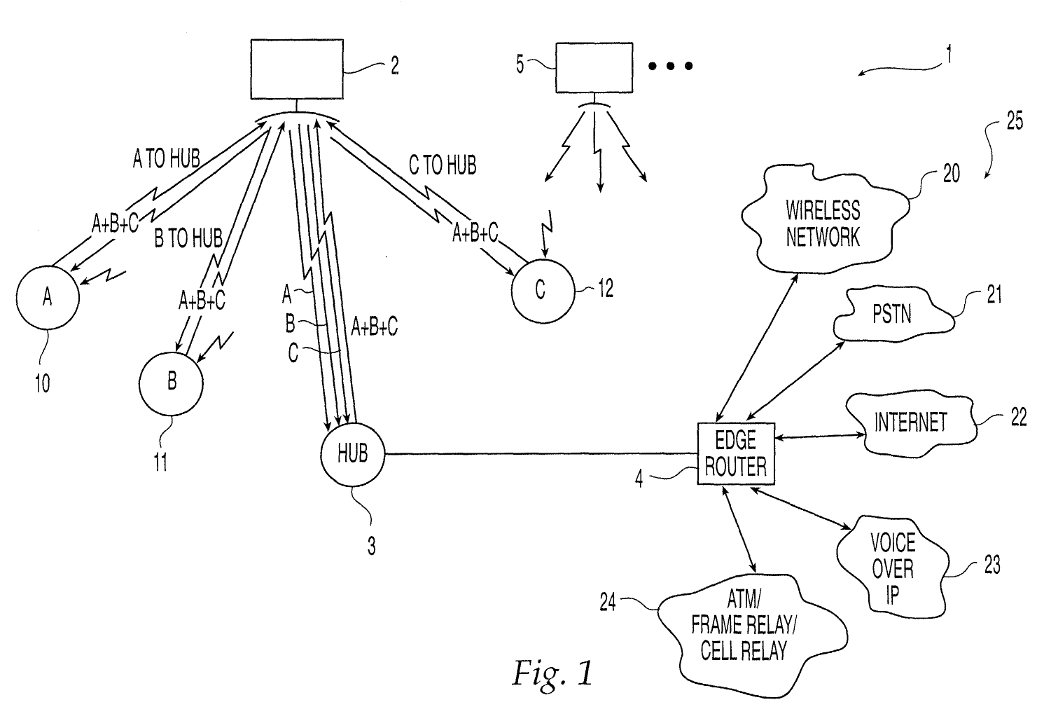

Referring to FIG. 1, an exemplary embodiment of a broadband network 1 is shown. The broadband network 1 may include a plurality of earth stations 10, 11, 12, a satellite 2, and a hub 3. The hub 3 may be configured to include and/or communicate with an edge router 4 which may be coupled to one or more terrestrial networks 25. For example, the edge router 4 and/or hub 3 may be coupled to a wireless network 20, a public switched telephone network 21, the Internet 22, a private IP network (e.g., supporting voice over IP), and/or an ATM, Frame Relay, and/or cell relay network 24. The broadband network 1 may be configured such that traffic passing to and from the plurality of earth stations 10, 11, 12, passes through the hub 3 prior to being communicated to one or more of the terrestrial networks 25.

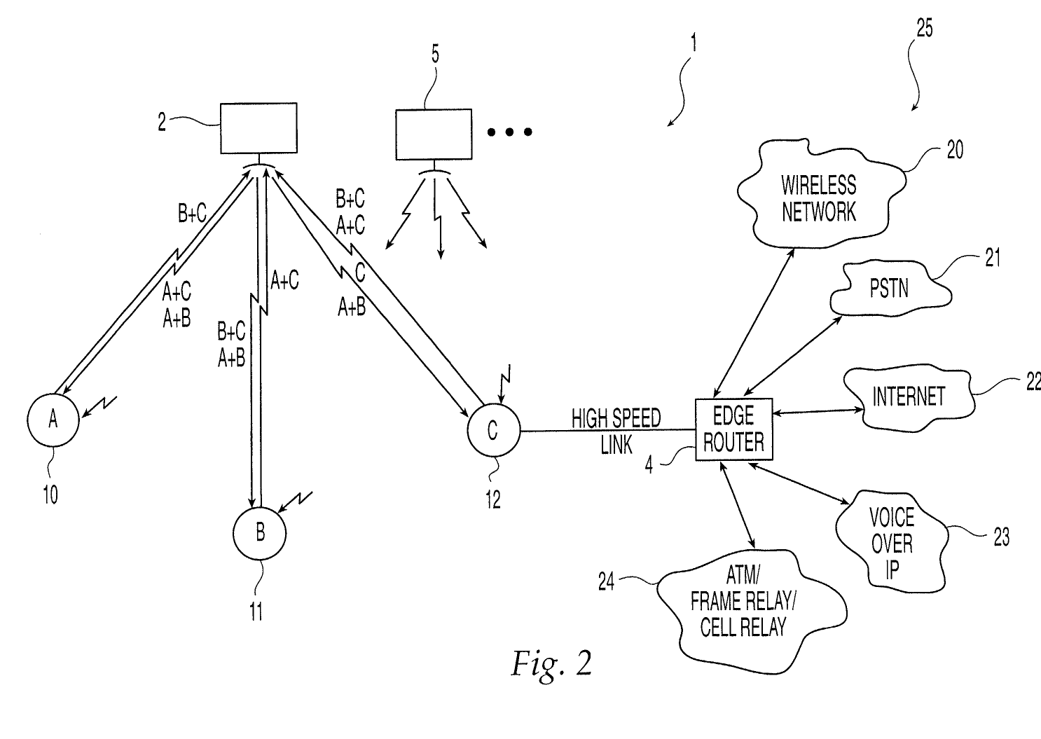

Referring to FIG. 2, an alternative embodiment of the broadband network 1 is shown. In this embodiment, a plurality of earth stations 10, 11, 12 may communicated with each other via a satellite 2. One or more of the earth stations may be configured to incorporate the functions of the hub 3 shown in FIG. 2. In this manner, any of the other earth stations may utilize the terrestrial networks by communication with one of the earth stations such as earth station 12.

FIGS. 4-7 show exemplary embodiments of the earth stations 10, 11, 12, and/or the hub 3. For example, FIG. 4 shows an antenna 41 communicating with a server/switch 40. The server/switch 40 may be variously configured to include a server, a switch, a router, and/or other processor for assembling communications to or from the antenna 41 with a plurality of local resources such as cable set-top devices, telephones, and computers. These devices may either be integrated into the server/switch 40 and/or located external to the server/switch 40. Where devices are located external to the server/switch 40, it may be desirable to couple the devices via one or more network(s) 45 such as a LAN IP network and/or one or more other interfaces 46. The network 45 may be coupled to one or more devices such as video device(s) 43 (e.g., IP enabled cable settop terminals), phone(s) 44 (e.g., IP enabled phones), and/or data devises 42 (e.g., one or more network ready PCS). Devices coupled to the other interfaces 46 may include a plain old telephone, a conventional cable and/or satellite settop device, a PABX, and/or other devices.

In embodiments where the server/switch 40 operates as a hub, the server/switch 40 may be coupled to one or more of the terrestrial networks 25 using either the network interface 45 and/or the other interface 46. In still further embodiments, the antenna 41 may support one or more additional download feeds 47, 48 which may be used to receive multicast data, digital video broadcast, direct broadcast television/radio, and/or other broadband data. For example, one, two, or more additional satellites 5 may provide broadcast data to the plurality of earth stations. The feeds 47, 48 may be coupled to the server/switch 40 through the satellite transceiver card 50 and/or output to separate devices. Where separate devices are utilized, the separate devices may include, for example, one or more settop decoders such as a direct broadcast television decoder box. The antenna 41 may be variously configured to conform to conventional VSAT specifications. Alternatively, the antenna 41 may comprise an antenna capable of sending and receiving VSAT signals as well as receiving direct broadcast televisions signals from a plurality of satellites. Such an antenna system is described in Multi Feed Reflector Antenna to Danny Spiritus, filed on Apr. 7, 2000, Ser. No. 60/195,247, and herein incorporated by reference.

In still further embodiments of the device shown in FIG. 4, the server/switch may be a high speed switch such as commercially available frame relay switches and statistical multiplexers.

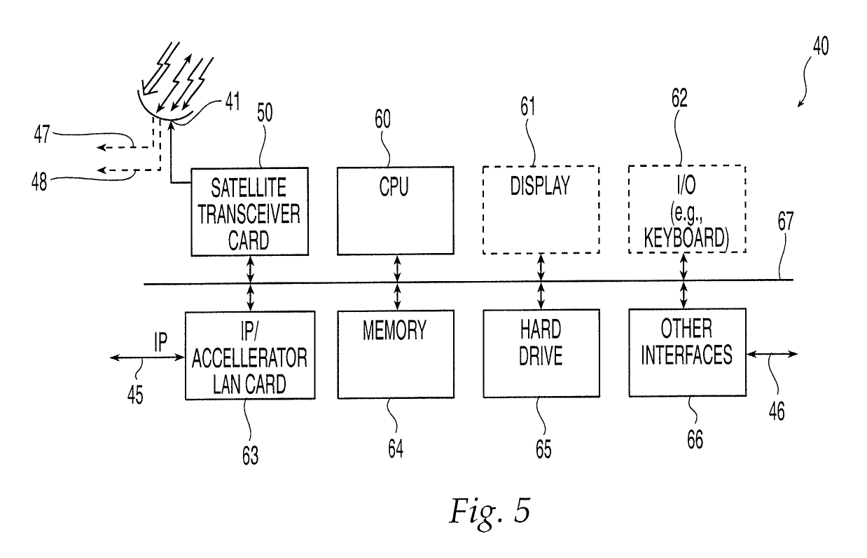

FIG. 5 shows an alternative embodiment of the earth station. Referring to FIG. 5, the server/switch 40 may include a system bus 67 coupling one or more of a satellite transceiver card 50, a processor such as central processing unit (CPU) 60, a network card 63 such as an IP based LAN card, memory 64, permanent storage 65 (e.g., a hard drive). The server/switch may optionally include a module supporting other interfaces 66, a display 61, and/or an I/O interface 62 such as a keyboard and mouse for interfacing with a local operator. In the simplest embodiments, the earth station may be entirely contained within a personal computer. In other embodiments, the earth station may be configured in a separate stand alone unit which is pre-configured and sold without a display and/or local operator interface.

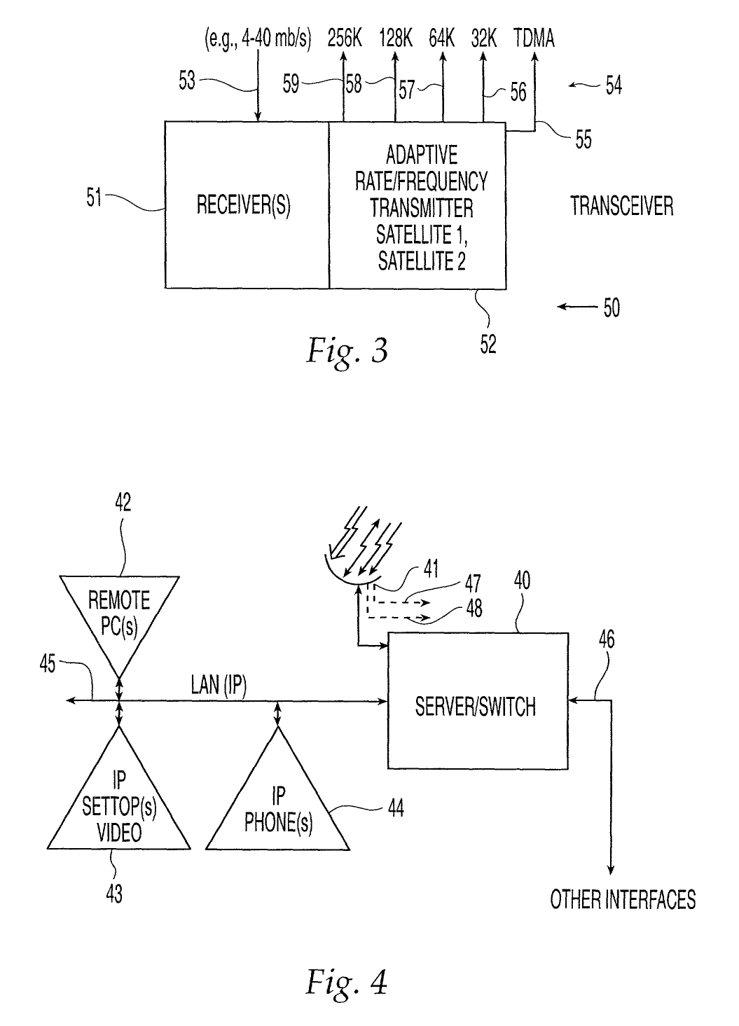

The satellite transceiver card 50 may be variously configured. In exemplary embodiments, the satellite transceiver card may simply be a TDMA or single carrier per channel based transceiver. In other embodiments, the transceiver card may have the ability to adapt to different rates and/or frequencies. For example, referring to FIG. 3, the transceiver card 50 may include one or more high speed receiver(s) 51 receiving one or more high speed downlink channels 53. The transceiver card 50 may also include one or more uplink transmitter(s). The uplink transceiver may be a single carrier per channel, a TDMA based system, or an adaptive system allowing dynamic reconfiguration of the uplink channel bandwidth and/or frequency. In one exemplary embodiment, the transmitter card 52 may adapt to anyone of a number of different frequencies and/or channels. In the embodiment illustrated in FIG. 3, the uplink channels 54 include 32K, 64K, 128K, 256K, and/or a higher speed TDMA link 55. Where the transmitter card includes adaptive circuitry, the earth station may dynamically reconfigure the uplink bandwidth to add additional channels and/or switch to higher capacity channels. In this manner, the earth station may adapt to changes in demand caused by, for example, video conferencing sessions.

An exemplary application for the adaptive transmitter circuitry includes bandwidth on demand to maximize bandwidth usage across diverse time zones. For example, it is often desirable to increase remote uplink data rates to increase inbound traffic flows during peak demand periods in a particular time zone. This may be determined by monitoring the traffic over a period of time or more desirably through monitoring queue levels. In exemplary embodiments where the queue level passes a upper predetermined threshold, the adaptive transmitter may open an second channel or switch to a higher bandwidth channel. This may be done via any suitable coordination mechanism such as through a network management center keeping track of available network bandwidth resources. When the queue drops below a settable low threshold, the network resources may be released and the adaptive transmitter may return to a lower level uplink. This may also be coordinated via one or more network management centers and include either releasing uplink channels, releasing a higher speed uplink channel, and/or releasing time slots in a TDMA link. The use of fast acquisition units is desirable to minimize the need for retransmission of data and disruption of calls during allocation/reallocation of resources. In some embodiments, it may be desirable to begin usage the alternative bandwidth resource before releasing the existing resources to avoid any data loss and/or data delays during signal acquisition.

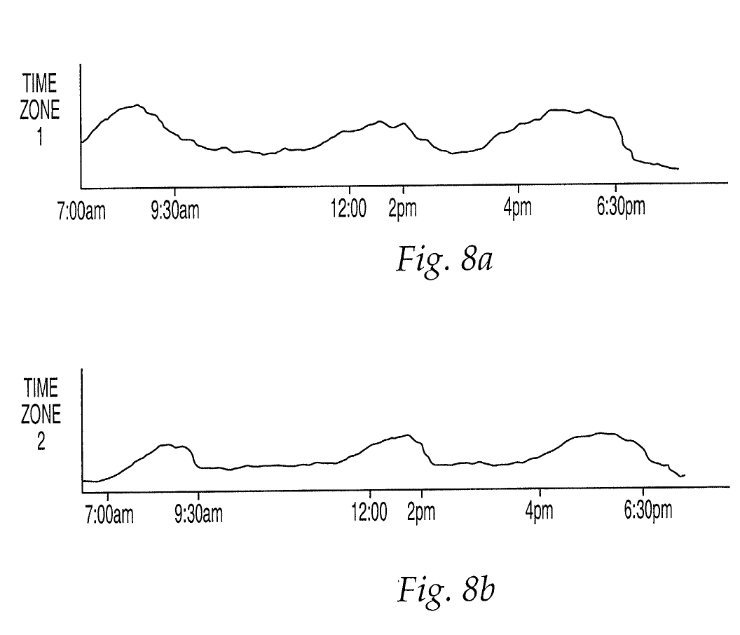

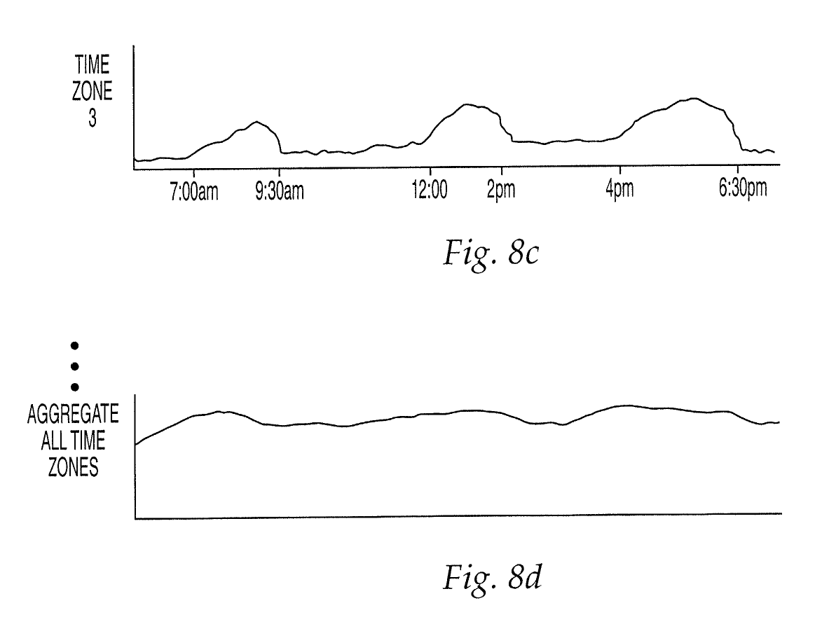

Referring to FIG. 8, the bandwidth on demand allocation is particularly useful where the satellite links are distributed over large geographic regions. Traffic profiles tend to be similar among communities of like size and economic profile, varying as a function of time-of-day, and to a lesser extent, day-of-week. Where a satellite covers 4, 5, or more different time-zones, peak traffic loads are shifted in time. For example, many corporations teach time management skills of having employees check their e-mail and phone messages in the morning, at lunch, and in the evening. Thus, for many regions, there are three distinct peaks in traffic. Rather than size every link in every time zone for the maximum expected offered load, it may be desirable to provide a committed information rate which varies over the day depending on time period. Thus, a user may purchase a higher committed information rate between the hours of 8 and 5, between the hours of 8-9:30, 11-1, and 4-5, or other similar time slots. Where many time zones are aggregated (e.g., time zones 1-3 in FIG. 8), the average traffic over all time zones is fairly constant. This is shown graphically in FIG. 8(d) which is a composite of all traffic from all time zones covered by satellite 2. In this manner, network resources may be balanced between maximizing throughput for a given earth station and minimizing total network bandwidth requirements. Thus, costs to the end user may be reduced.

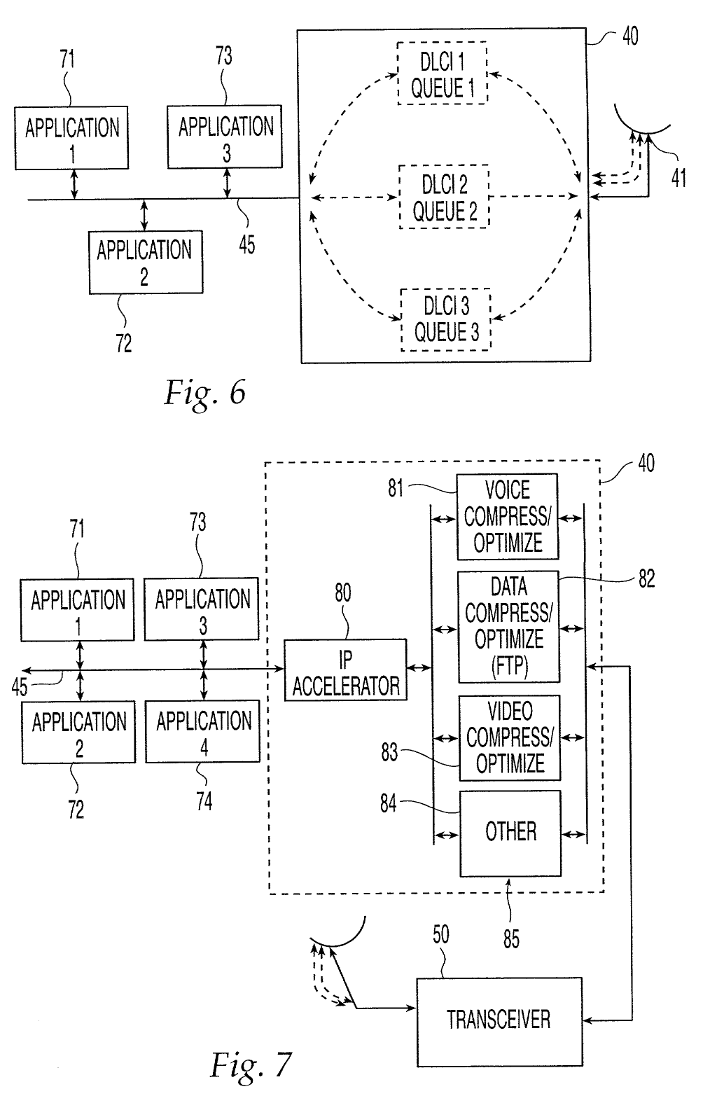

FIG. 6 shows a partial block, partial logical flow diagram of embodiments of the earth station shown in FIG. 4 and 5. In FIG. 6, a plurality of applications 71-73 are running in the earth station. For simplicity, the applications are shown running on network 45, but may be running entirely within one connected device or entirely within the server/switch 40. The applications may, for example, comprise telephony, data, and/or video applications. The applications may be assigned various levels of priority based on the throughput requirement of the different applications. For example, video often requires high throughput and low latency times, followed by voice and last by data. In the present embodiment, where the application is associated with a different IP address (or port address), it is possible to map the IP address (or port address) to a particular data link control identifier (DLCI). This mapping is particularly useful where the server/switch 40 comprises a frame relay switch coupled to a plurality of devices over an IP network. The various data link control identifiers within the server/switch 40 may be assigned different levels of priority. Thus, applications concerning IP telephony would be assigned a higher level of priority than a data application. Where the IP telephony originates from an IP telephone, the IP address of the telephone may be mapped by the server/switch 40 to a particular DLCI having a priority level associated with voice transmissions. In this manner, it can be assured that the voice transmissions over the satellite are prioritized over data. Where the IP telephony originates from an IP phone within a connected device such as a PC, it may be assigned a particular port address. The port address may then be mapped by the server/switch 40 to the same DLCI assigned to handle telephony.

A similar arrangement may be applied to both voice and data transmissions. For example, voice devices having separate IP addresses or ports are mapped to a second DLCI, and data devices with separate IP address or ports are mapped to a third DLCI. Other devices may be mapped to one or more miscellaneous DLCIs. The switch/server 40 may then assign differing priority levels to the various DLCIs and adjust the various queue sizes and priorities based on the type of data being stored in the queue. The IP telephony system may be implemented for all telephony applications, or may be phased in over time. For example, existing telephones may be connected to an existing PABX or statistical multiplexer. The PABX or statistical multiplexer may be coupled to one of the ports on the server/switch and serviced by its own DLCI or share the DLCI used by other telephony applications. For example, again referring to FIGS. 4 and 5, the PABX or statistical multiplexer may be coupled to one of the other interfaces 46 and input into, for example, the voice DLCI (DLCI 1) or into a separate dedicated DLCI and associated queue. In either event, the traditional PABX based telephones may coexist with newer IP based telephones. This provides a gradual migration path allowing existing telephones to remain in service while allowing the site to migrate to more advanced IP telephones.

FIG. 7 shows yet another embodiment of the server/switch 40 shown in partial block, partial logical flow diagram form. FIG. 7 is similar to FIG. 6 in that a plurality of applications may be present either on the network 45 and/or within the server/switch 40. The server/switch 40 may be implemented in any manner shown herein to accomplish the functions described in FIG. 7. Alternatively, a plurality of dedicated processing devices may be implemented which convert the IP packets from network 45 and/or internal applications 71-74 into intermediate data packets. The intermediate data packets may include source and/or destination addresses, but be otherwise striped of all overhead via IP accelerator 80. The intermediate data packets may then be compressed/optimized for transmission over the satellite link.

The conversion between IP data packets, intermediate data packets, and compressed/optimized data packets may occur in a frame relay switch, in the CPU 60, in the IP accelerator 80, in one or more of the optimization modules 85, and/or in a combination of any of the foregoing. For example, it may be desirable to include a separate IP accelerator configured to convert frame relay frames into IP data packets. Alternatively, separate modules 81-84 may be utilized to optimize the processing and priority scheduling for different types of data. For example, a voice compression/optimization module 81 may be utilized to compress/optimize the voice into appropriate voice packets for transmission over the satellite 2; a data compression/optimization module 82 may be utilized to compress/optimize the data into appropriate data packets for transmission over the satellite 2; a video compression/optimization module 83 may be utilized to compress/optimize the video into appropriate video packets for transmission over the satellite 2; and other modules may be added as appropriate to compress/optimize other types of data for transmission over the satellite. For example, an optimization module 84 may comprise a web page accelerator/cache for use over satellite networks. One such device and method is shown in U.S. patent application Ser. No. 60/182,537, filed Feb. 15, 2000, entitled System and Method For Internet Page Acceleration, in the name of Aditya N. Chatterjee et al., herein incorporated by reference. This device and method may be employed in any of the earth stations described herein.

For example, since the source of the transmission received at the hub is known to be from the sending earth station, the source address may not be needed in the transmission. This information may be reconstructed at the Hub. It may be that for certain types of data only a port address is necessary if anything. Thus, the transmissions may be substantially compressed by using a more efficient protocol (e.g., frame relay, cell relay, and/or ATM) over the Satellite. In many embodiments, a protocol similar to frame relay provides the most efficient use of the bandwidth across the satellite.

In operation, the broadband network 1 may be configured to allow voice, data, and video communication to and from any of the earth stations 10, 11, and 12. In exemplary embodiments, the earth stations may be entirely located in the home of a user. For example, earth station 10 may be located in a user's home, earth station 11 in another user's home, and earth station 12 in a business, an Internet Service Provider (ISP), or as part of a centralized hub facility. Where the earth station is implemented in a user's home, the earth station may comprise a server and/or a stand alone unit implementing one or more of the functions of the earth station shown in FIGS. 4-7. In one exemplary implementation, the earth station may be configured as shown in FIG. 5 and as a standalone unit. In this embodiment, the user may program the earth station to perform a variety of functions. For example, the user may have one or more connected IP telephones and/or standard plain old telephones (POT). Where an IP telephone is utilized, the user may communicate over the network 45, through the LAN card 63, through the satellite transceiver card 50 and out over the antenna 41. The transfer from the LAN card 63 may occur under the direction of the processor 60, through the memory (e.g., using direct memory access (DMA)), and/or directly to the satellite transceiver card 50. Where the transfer is under control of the LAN card or the processor, accommodation may be made to prioritize voice and video over other types of data. When the IP call set-up data is output over the antenna, through the satellite 2 and to the hub 3 (FIG. 1) or earth station 12 (FIG. 2).

The Hub and/or earth station may be connected directly or through an edge router 4 to a plurality of networks such as wireless networks 20, public switched telephone networks 21, the Internet 22, Voice over IP networks 23, and/or ATM/Frame Relay/Cell Relay networks 24. In either event, an IP call will need to utilize a conventional IP/PSTN call set-up and signalling gateway. Communications over the LAN preferably utilize a conventional voice over IP protocol such as H.323. H.323 provides a protocol for audio, video, and data communications across IP based networks which allows equipment from multiple vendors to interoperate. In this manner, users may integrate IP telephones which support H.323 into their home or local business with out regard to the equipment in the hub or earth station 12. Further, equipment in the hub or earth station 12 can use standard IP/PSTN gateways to convert the IP calls into calls over the public switched telephone network. For example, the hub and/or edge router may include a signaling gateway to setup the call over the public switched telephone network. In this manner, a user located at earth station 10 may use the satellite to setup calls over the public switched telephone network without the need to have any interface with the local telephone company. Thus, the hub 3 and/or earth station 12 may allow telephone calls to and from the remote earth stations.

The user's home may be provisioned with either one or a plurality of different phone lines. For example, where an adaptive transceiver 52 is utilized, the user may have multiple simultaneous phone calls, Internet access, and receipt of 500 or more television channels all through the satellite connection without need to access the local phone company or cable company. Access may be of a very high quality with high speed internet access, multiple phone lines each having premium service options. For example, where there is little activity, the user may utilize one uplink channel or no uplink channels. When the user wishes to initiate a phone call or activates an Internet link, the adaptive transceiver 52 may request uplink channel capacity. The uplink channel may then be dynamically allocated to the user. Where the user requires multiple simultaneous phone lines and/or an Internet connection, the adaptive transceiver may allocate additional bandwidth by switching to a higher data rate uplink carrier (e.g. 64K or 128K) during the period of peak usage. When the calls have terminated, the earth station 10 may release the uplink resources for use by other earth stations. This configuration allows the system to service hundreds of thousands of home/business users.

The transmission of the voice calls may be prioritized as discussed above over the satellite link such that the quality of service may be maintained. A similar prioritization of video calls may also be accomplished in the same manner as discussed above. This may be accomplished by minimizing the overhead associated with the IP packets to reduce the uplink data traffic and reduce delays.

Embodiments in accordance with the present invention may also be used for on-demand video delivery from the Internet. For example, where the user wishes to “rent” a movie from a movie rental company, e.g., Blockbusters™, the user may log onto a special Internet page, view the various titles, clips of the titles, and descriptions. When the user selects the movie, it may be downloaded and stored on the user's computer or in the earth station hard drive 65. The movie may be download and stored in its entirety and/or stored in segments. The user may thereafter view the movie with start, stop and pause commands directly from the server 40 or from an attached television such as a TV coupled to the other interfaces 46.

Phone calls may be made and received in a similar fashion as discussed above for wireless networks and/or voice IP telephony networks. Similarly, data may be routed over the Internet in a conventional fashion or diverted to any one of a number of private networks such a corporate WAN. In one exemplary embodiment, where a plant is located in a remote location, the employees may each be coupled to the satellite system and then hooked directly to the corporate WAN such at ATM/Frame Relay/Cell Relay network 24. In this manner security may be enhanced. As an additional precaution, the uplink and downlink satellite traffic may be encrypted/decrypted by the earth stations prior to sending out over the open air waves.

Although several embodiments of the invention have been described herein, other modifications will become apparent to those skilled in the art. The appended claims are intended to cover all such modifications.

What is claimed is:

1. An apparatus for coupling download feeds from a satellite to a server/switch, comprising a satellite transceiver card receiving broadband data through said download feeds, wherein said satellite transceiver card dynamically allocates bandwidth.

2. An apparatus for coupling download feeds from a satellite to a server/switch, as recited in claim 1, wherein said satellite transceiver card is a TDMA based transceiver.

3. An apparatus for coupling download feeds from a satellite to a server/switch, as recited in claim 1, wherein said satellite transceiver card is a single carrier per channel based transceiver.

4. An apparatus for coupling download feeds from a satellite to a server/switch, as recited in claim 1, wherein said satellite transceiver card can adapt to one of different data rates, different frequencies, and different data rates and frequencies.

5. An apparatus for coupling download feeds from a satellite to a server/switch, as recited in claim 4, wherein said satellite transceiver card comprises at least one high speed receiver receiving at least one high speed downlink channel.

6. An apparatus for coupling download feeds from a satellite to a server/switch, as recited in claim 4, wherein said satellite transceiver card comprises at least one uplink transmitter.

7. An apparatus for coupling download feeds from a satellite to a server/switch, as recited in claim 6, wherein said uplink transmitter is one of a single carrier per channel, a TDMA based system, and an adaptive system allowing dynamic reconfiguration of one of uplink channel bandwidth, frequency, and bandwidth and frequency.

8. An apparatus for coupling download feeds from a satellite to a server/switch, as recited in claim 6, wherein said transmitter adapts to one of a number of different frequencies, different channels and different frequencies and channels.

9. An apparatus for coupling download feeds from a satellite to a server/switch, as recited in claim 8, wherein said different channels include 32K, 64K, 128K, 256K, and a higher speed TDMA link.

10. An apparatus for coupling download feeds from a satellite to a server/switch, as recited in claim 6, wherein said satellite transmitter comprises adaptive circuitry, so that an earth station may dynamically reconfigure the uplink bandwidth to add additional channels, switch to higher capacity channels, and add additional channels and switch to higher capacity channels, so that said earth station adapts to changes in demand.
